(19) United States
(12) Patent Application Publication
(10) Pub. No.: US 2011/0262095 A1
(43) Pub. Date: Oct. 27, 2011

(54) REMOVABLE FIBER OPTIC SPLICE TRAY

(76) Inventors: Grzegorz Fabrykowski, Strykow (PL); Norbert Kaszycki, Zagorz (PL); Robert Tomasz Klak, Zdunska Wola (PL); Grzegorz Konrad Gralewski-Sek, Lodz (PL)

(21) Appl. No.: 13/089,692

(22) Filed: Apr. 19, 2011

Related U.S. Application Data
(60) Provisional application No. 61/327,234, filed on Apr. 23, 2010.

(51) Int. Cl. G02B 6/44

(52) U.S. Cl. 385/135

(57) ABSTRACT

A fiber optic splice tray having a first side for connecting optical fibers, and a second side for splicing optical fibers is disclosed. The splice tray is removably mountable to a base of an optical fiber distribution box in such a way that the fiber optic cables remain connected at the first side when the splice tray is removed from and mounted to the base. In this way, splicing of optical fibers in the fiber optic cables may be conveniently performed outside of the optical fiber distribution box without disturbing the interconnections of the fiber optic cables. When the splicing is completed the splice tray, with the fiber optic cables interconnected, may be re-installed in the box. A passage allows optical fibers to pass between the first side and the second side. The splice tray is reversibly mountable in that either side of the splice tray may be mounted towards the base. The box has a cover that removably attaches to the base and over the splice tray.

### RELATED APPLICATIONS

The present application claims priority to U.S. Ser. No. 61/327,234 filed on Apr. 23, 2010 and entitled “REMOVABLE FIBER OPTIC SPLICE TRAY”, the contents of which are incorporated by reference.

### BACKGROUND

The disclosure relates to fiber optic splice trays, and, more particularly, to a fiber optic splice tray that is removably installed in an optical fiber distribution box, such that the splice tray may be removed from the optical fiber distribution box without requiring the disconnection of the fiber optic cables entering the box.

### TECHNICAL BACKGROUND

In the world of the ever-increasing need for broadband bandwidth fiber optic cables have become the main part of telecommunication networks. Fiber optic cables can transmit voice signals, data signals and video signals for very long distances with very high speed. Developments of optic telecommunication networks allow the connection of the end user directly to the optical fiber. This kind of network technology known as FTTH technology (fiber to the home) requires extending an “all optical” communication network closer to the subscribers. As a result such telecommunication networks include large number distribution points from a distribution cable to an end user or subscriber.

Typically, the distribution points include an enclosure, such as an optical fiber distribution box, that provides for fiber optic cables interconnections and houses the necessary optical components for extending the all optical network to the subscriber. One such optical component may be a splice tray having one or more splice holders. The splice holders provide a structure for holding splices of the optical fibers of one or more fiber optic cables to the optical fibers of one or more other optical fibers.

### SUMMARY

Embodiments disclosed in the detailed description include a fiber optic splice tray having a first side for connecting optical fibers, and a second side for splicing optical fibers. The splice tray is removably mountable to a base of an optical fiber distribution box in such a way that the fiber optic cables remain connected at the first side when the splice tray is removed from and mounted to the base. In this way, splicing of optical fibers in the fiber optic cables may be conveniently performed outside of the optical fiber distribution box without disturbing the interconnections of the fiber optic cables. When the splicing is completed the splice tray, with the fiber optic cables interconnected, may be re-installed in the box. A passage allows optical fibers to pass between the first side and the second side. The splice tray is reversibly mountable in that either side of the splice tray may be mounted towards the base. The box has a cover that removably attaches to the base and over the splice tray.

The first side has at least one fiber optic adapter mounted thereto, which may be one or more multiple fiber adapters and/or one or more single fiber adapters. Thus, the at least one fiber optic adapter may comprise a plurality of fiber optic adapters, whether multiple fiber adapters, single fiber adapters or a combination thereof. The splice tray may have a connection panel attached to it with the one or more multiple fiber adapters and/or one or more single fiber adapters mounted to the connection panel. A first portion of the plurality of fiber optic adapters may be located toward a first end of the connection panel and a second portion of the fiber optic adapters may be located toward a second end of the connection panel. Additionally or alternatively, one or more fiber optic cable ports may be mounted in or to the connection panel. Thus, a plurality of fiber optic cable ports may be mounted in or to the connection panel. A first portion of the plurality of fiber optic cable ports may be located toward a first end of the connection panel and a second portion of the fiber optic cable ports may be located toward a second end of the connection panel.

The second side of the splice tray has a splice area with a first splice section comprising at least one mechanical splice holder and a second splice section comprising at least one crimp splice holder. The at least one mechanical splice holder comprises a plurality of mechanical splice holders. The at least one crimp splice holder comprises a plurality of crimp splice holders. The second side may also have an optical fiber routing guide.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is an elevated, perspective view of a first side of an exemplary splice tray illustrating a connection panel with fiber optic adapters for interconnecting fiber optic cables and fiber optic cable ports for receiving fiber optic cables;

FIG. 2 is an elevated, perspective view of a second side of the splice tray of FIG. 1 illustrating a splicing area having a crimp splicing section and a mechanical splicing section;

FIG. 3 is an elevated, perspective view of the splice tray of FIGS. 1 and 2 illustrating first side cover and second side cover;

FIG. 4 is an elevated, perspective view of the splice tray of FIGS. 1 and 2 removably mounted in a base of an exemplary optical fiber distribution box with the second side of the splice tray facing the base;

FIG. 5 is an elevated, perspective view of the splice tray of FIGS. 1 and 2 removably mounted in a base of an exemplary optical fiber distribution box with the first side of the splice tray facing the base;

FIG. 6 is an elevated, exploded perspective view of the splice tray of FIGS. 4 and 5 with the first side cover, the second side cover, the base of the optical fiber distribution box, and a cover of the optical fiber distribution box;

FIG. 7 is an elevated, exploded perspective view of the optical fiber distribution box with the cover removably attached to the base.

### DETAILED DESCRIPTION

Embodiments disclosed in the detailed description include a fiber optic splice tray having a first side, or patching side, for connecting optical fibers, and a second side, or splicing side, for splicing optical fibers. The splice tray is removably mountable to a base of an optical fiber distribution box in such a way that the fiber optic cables remain connected at the first side when the splice tray is removed from and mounted to the base. In this way, splicing of optical fibers in the fiber optic cables may be conveniently performed outside of the optical fiber distribution box without disturbing the interconnections of the fiber optic cables. When the splicing is completed the splice tray, with the fiber optic cables interconnected, may be re-installed in the box. A passage allows optical fibers to pass between the first side and the second side. The splice tray is reversibly mountable in that either side of the splice tray may be mounted towards the base. The box has a cover that removably attaches to the base and over the splice tray.

The first side has at least one fiber optic adapter mounted thereto, which may be one or more multiple fiber adapters and/or one or more single fiber adapters. Thus, the at least one fiber optic adapter may comprise a plurality of fiber optic adapters, whether multiple fiber adapters, single fiber adapters or a combination thereof. The splice tray may have a connection panel attached to it with the one or more multiple fiber adapters and/or one or more single fiber adapters mounted to the connection panel. A first portion of the plurality of fiber optic adapters may be located toward a first end of the connection panel and a second portion of the fiber optic adapters may be located toward a second end of the connection panel. Additionally or alternatively, one or more fiber optic cable ports may be mounted in or to the connection panel. Thus, a plurality of fiber optic cable ports may be mounted in or to the connection panel. A first portion of the plurality of fiber optic cable ports may be located toward a first end of the connection panel and a second portion of the fiber optic cable ports may be located toward a second end of the connection panel.

The second side of the splice tray has a splice area with a first splice section comprising at least one mechanical splice holder and a second splice section comprising at least one crimp splice holder. The at least one mechanical splice holder comprises a plurality of mechanical splice holders. The at least one crimp splice holder comprises a plurality of crimp splice holders. The second side may also have an optical fiber routing guide.

The multiple fiber adapter may be one that provides for multi-fiber connector to multi-fiber connector interconnection, such as, for example, an MTP® connector, or an OptiTIP® connector, as commercially available from Corning Cable Systems LLC of Hickory, N.C., or other types of multi-fiber adapters. Additionally or alternatively, the fiber optic adapter may be one that provides for single fiber connector to single fiber connector interconnection, for example an SC connector, LC connector, or OptiTAP® connector, as commercially available from Corning Cable Systems LLC of Hickory, N.C., or other types of single fiber adapters.

As used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163, the disclosures of which are incorporated herein by reference in their entireties.

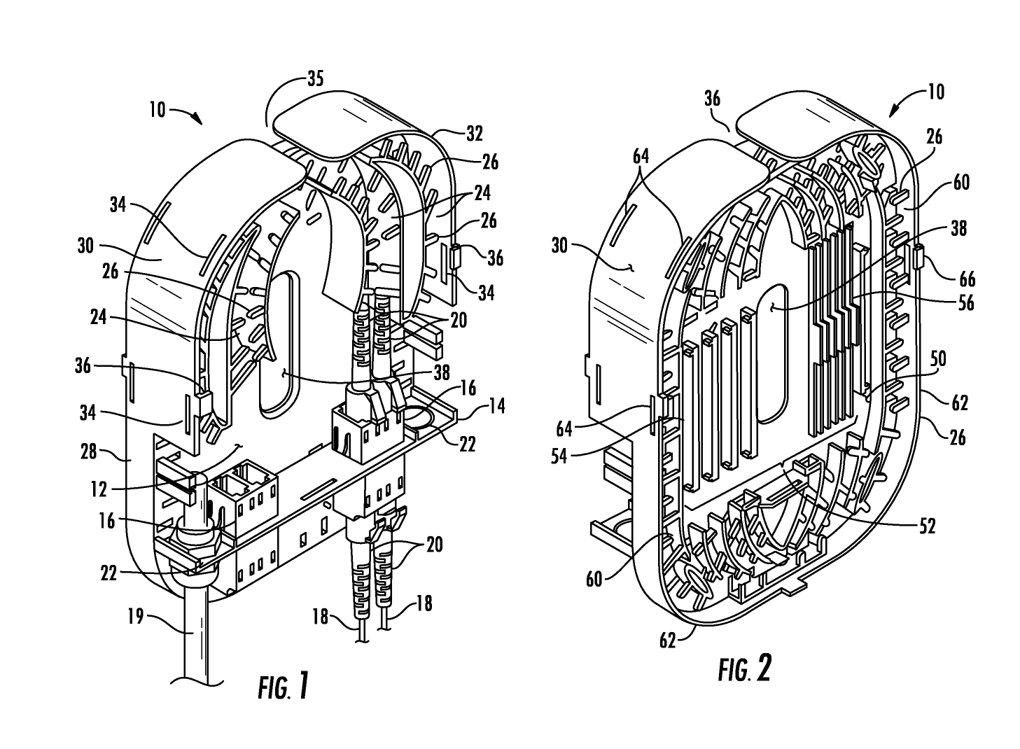

FIGS. 1-7 illustrate a fiber optic splice tray 10 according to an exemplary embodiment. FIG. 1 is an elevated, perspective view of a first side 12 of the splice tray 10 having a connection panel 14 with one or more fiber optic adapters 16 configured for interconnecting fiber optic cables 18, for example, distribution cables, terminated with connectors 20. One or more fiber optic cable ports 22 for receiving fiber optic cables 19, for example, an incoming feeder cable providing optical service from a provider, may also be mounted in or on the connection panel 14. It should be understood, that a distribution cable 18 may be connected to the splice tray 10 via a fiber optic cable port 22, while an incoming cable may be connected to the splice tray 10 via a fiber optic adapter 16. Fiber optic routing guides 24 extend from the first side 12. The routing guides 24 may have retention tabs 26 adapted to retain the fiber optic cables being routed in the routing guides 24.

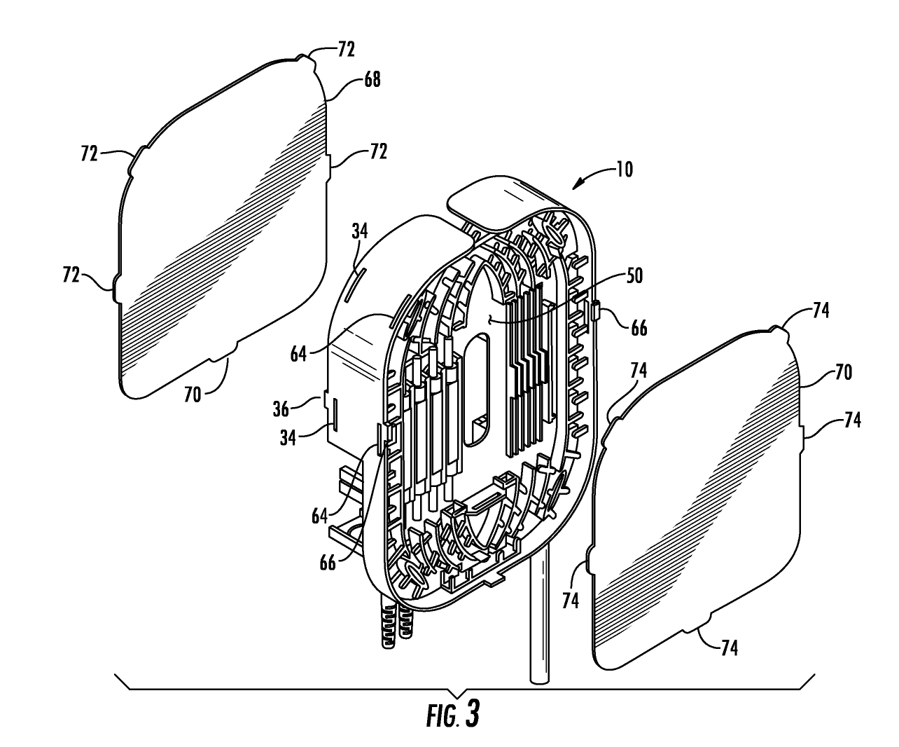

A perimeter 28 of the splice tray 10 is at least partially bounded by a rim 30. The rim 30 may have a first side wall 32 that extends from the first side 12 at least on a portion of the perimeter 28. One or more first side cover slots 34 extending through the first side wall 32 may receive protrusions extending from a first side cover (not shown on FIG. 1) for attaching the first side cover to the splice tray 10. A passageway 35 cut through the rim 30 provides a transition for fiber optic cables 18, 19 and optical fibers from the fiber optic cables 18, 19 between the first side 12 and a second side (see FIG. 2). The splice tray 10 may be mounted on and/or to a base of a distribution box. In this regard, mounting tabs 36 may be included to allow for the splice tray 10 to be mounted to a base in such a way as the first side 12 faces the base (see FIG. 4). An access hole 38 extends through the splice tray 10 to provide access to the base as will be described in more detail below.

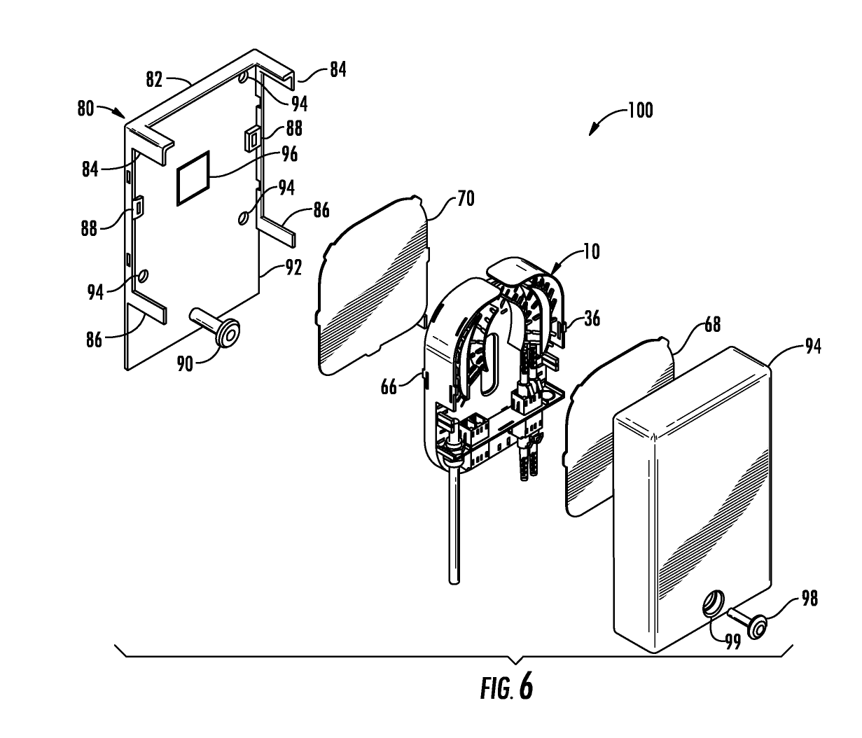

FIG. 2 is an elevated, perspective view of a second, or splicing, side 50 of the splice tray 10. The second side 50 is configured for mechanical and crimp, or fusion) splicing. Overlength storage may be around the splicing area. In this regard, the second side 50 includes a splicing area 52. The splicing area 52 may have a first, or mechanical, splicing section 54, and a second, or crimp or fusion, splicing section 56. Cable storage areas 58 extend from the second side 50 to provide for slack storage of fiber optic cable and/or optical fibers. Additionally, fiber optic routing guides 60 extend from the first side 50. The routing guides 60 may have retention tabs 26 adapted to retain the fiber optic cables being routed in the routing guides 60. The rim 30 may have a second side wall 62 that extends from the second side 50 at least on a portion of the perimeter 28. One or more second side cover slots 64 extending through the second side wall 62 may receive protrusions extending from a second side cover (not shown on FIG. 1) for attaching the second side cover to the splice tray 10. Mounting tabs 66 may be included to allow for the splice tray 10 to be mounted to a base in such a way as the second side 50 faces the base (see FIG. 5).

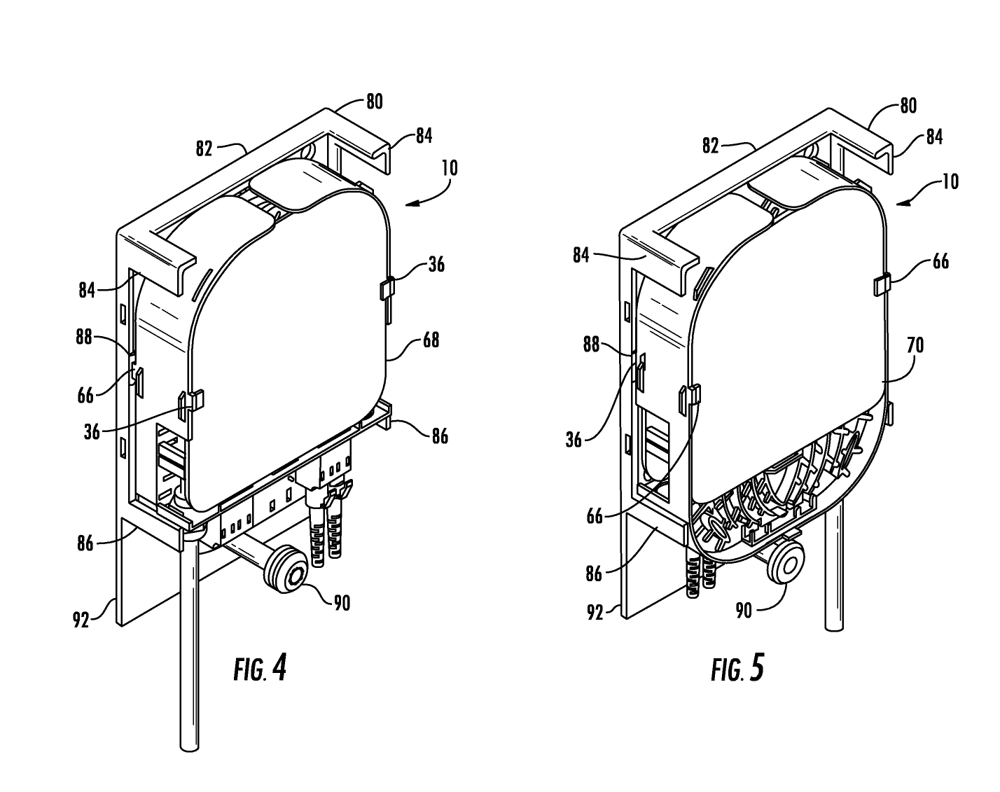

FIG. 3 is an elevated, perspective, exploded view of the splice tray 10 illustrating the second side 50 with first side cover 68 and second side cover 70. Protrusions 72 extend from the first side cover 68 and are configured to fit into respective first side cover slots 34 to removably attach the first side cover 68 to the splice tray 10. In a similar manner, protrusions 74 extend from the second side cover 70 and are configured to fit into respective first side cover slots 64 to removably attach the second side cover 70 to the splice tray 10. The first side cover 68 and the second side cover 70 provide protection for the components mounted in the first side 12 and the second side 50 of the splice tray 10.

FIGS. 4 and 5 illustrate the splice tray 10 removably mounted to the base 80. FIG. 4 is an elevated, perspective view of the splice tray 10 removably mounted to the base 80 with the first side 12 facing outwardly and the second side 50 facing toward the base 80. FIG. 5 is an elevated, perspective view of the splice tray 10 removably mounted to the base 80 with the second side 50 facing outwardly and the first side 12 facing toward the base 80. The base 80 has a frame 82 having upper extensions 84 and lower extensions 86. The splice tray 10 positions on the frame 82 within the area defined by the upper extensions 84 and the lower extensions 86. In the case where the second side 50 is facing toward the base 80 as shown in FIG. 4, mounting tabs 66 insert into receivers 88 on the frame 82. The mounting tabs 66 snap into the receivers 88 such that the splice tray 10 is supported by the frame 82, and, thereby, removably mounted to the base 80. In a similar manner, in the case where the first side 12 is facing toward the base 80 as shown in FIG. 5, mounting tabs 36 insert into receivers 88 on the frame 82. The mounting tabs 36 snap into the receivers 88 such that the splice tray 10 is supported by the frame 82, and, thereby, removably mounted to the base 80. Force applied to the splice tray 10, forces the mounting tabs 36, 66 to be released from the receivers 88 and the splice tray to be removed from the base 80. Cover boss 90 extends from back 92 of the base 80. The cover boss 90 may be threaded such that it may receive a bolt or screw to attach the cover (not shown in FIGS. 4 and 5) to the base 80. In this manner, the splice tray 10 can be removed from the base 80 and, thereby, from the distribution box to allow splicing to be performed outside of the distribution box. When the splicing is completed the splice tray 10 is re-installed on the base 80 of the distribution box.

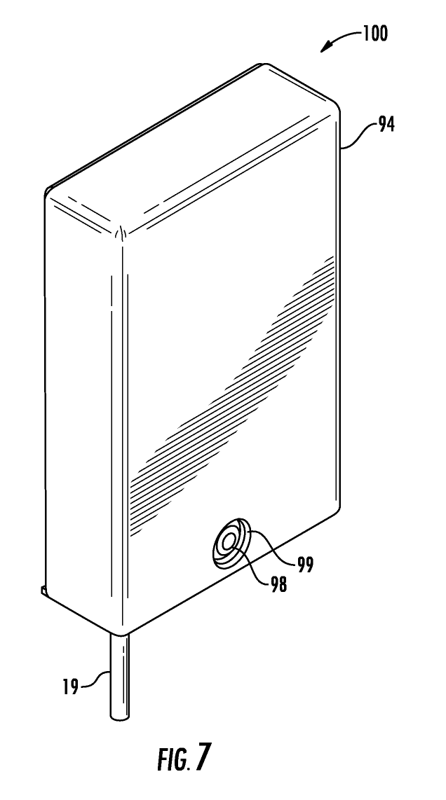

FIG. 6 is an elevated, exploded perspective view of a distribution box 100 illustrating the splice tray 10, the first side cover 68, the second side cover 70, the base 80 and a cover 94. Mounting holes 94 may be used to mount the base 80 on the wall or other surface. Wall access port 96 through the back 92 of the base 80 may be used to transition into the distribution box 100 incoming cables routed through and/or inside the wall. Additionally, the wall access port 96 may be generally aligned with the access hole 38 to allow access to the wall access port 96 when the splice tray 10 is removably mounted to the base 80. The cover 94 attaches to the base 80 and over the splice tray 10. A bolt, screw or other fastener 98 may be used to attach the cover 94 to the base 80 via the cover boss 90, for example, by threading the fastener through a fastener hole 99 into the cover boss 90. Special fasteners 98 may be provided to affix the cover 94 to the base 80.

FIG. 7 is an elevated, exploded perspective view of the distribution box 100 with the cover 94 removably attached to the base 80 using fastener 98 in fastener hole 99. With the cover 94 installed the distribution box 100 may be sealed with the splice tray 10 inside. The box with the splice tray can be installed in a subscriber premises, such as an apartment, or the like, and/or installed in a basement of a multiple dwelling unit and be environmentally sealed allowing for when different protection rating is expected. Incoming cable 19 can be managed on the wall and/or inside the wall. Strain relief may also be provided with the box, to, without limitation, strain relief the cable from the wall which can be required in subscriber premises. The splice tray 10 may be removed from the distribution box 100 for installing cable and performing splicing close to the splice equipment. Also splice tray 10 may then be installed on the base 80 with either the first side 12 or the second side 50 towards the base 80 depending on need. In this manner, the splice tray 10 is reversibly mountable to the base 80, and, thereby, in the distribution box 100.

It will be apparent to those skilled in the art that various modifications and variations can be made without departing from the spirit or scope of the invention.

What is claimed is:

1. A fiber optic splice tray, comprising:
a first side for connecting optical fibers of fiber optic cables;
a second side for splicing optical fibers, wherein the splice tray is removably mountable to a base of an optical fiber distribution box, and wherein the fiber optic cables remain connected at the first side when the splice tray is removed from and mounted to the base.

2. The fiber optic splice tray of claim 1, further comprising a passageway, wherein the passageway allows optical fibers to pass between the first side and the second side.

3. The fiber optic splice tray of claim 1, wherein the splice tray is reversibly mountable to the base with one of the first side and the second side facing toward the base.

4. The fiber optic splice tray of claim 1, wherein the box has a cover that removably attaches to the base and over the splice tray.

5. The fiber optic splice tray of claim 1, wherein the first side has at least one fiber optic adapter mounted thereto.

6. The fiber optic splice tray of claim 5, wherein the at least one fiber optic adapter is a multiple fiber adapter.

7. The fiber optic splice tray of claim 5, wherein the at least one fiber optic adapter is a single fiber adapter.

8. The fiber optic splice tray of claim 5, wherein the at least one fiber optic adapter is a plurality of fiber optic adapters.

9. The fiber optic splice tray of claim 1, wherein the first side has a connection panel attached thereto.

10. The fiber optic splice tray of claim 9, wherein at least one fiber optic adapter is mounted to the connection panel.

11. The fiber optic splice tray of claim 9, wherein the at least one fiber optic adapter comprises a plurality of fiber optic adapters.

12. The fiber optic splice tray of claim 9, wherein a first portion of the plurality of fiber optic adapters is located at a first end of the connection panel, and a second portion of the plurality of fiber optic adapters is located at a second end of the connection panel.

13. The fiber optic splice tray of claim 9, wherein at least one fiber optic cable port is mounted to the connection panel.

14. The fiber optic splice tray of claim 13, wherein the at least one fiber optic cable port comprises a plurality of fiber optic cable ports.

15. The fiber optic splice tray of claim 14, wherein a first portion of the plurality of fiber optic cable ports is located at a first end of the connection panel, and a second portion of the plurality of fiber optic cable ports is located at a second end of the connection panel.

16. The fiber optic splice tray of claim 1, wherein the second side comprises a splice area.

17. The fiber optic splice tray of claim 16, wherein the splice area comprises a first splice section comprising at least one mechanical splice holder.

18. The fiber optic splice tray of claim 17, wherein the at least one mechanical splice holder comprises a plurality of mechanical splice holders.

19. The fiber optic splice tray of claim 16, wherein the splice area comprises a second splice section comprising at least one crimp splice holder.

20. The fiber optic splice tray of claim 19, wherein the at least one crimp splice holder comprises a plurality of crimp splice holders.

21. The fiber optic splice tray of claim 1, wherein the second side comprises an optical fiber routing guide.
